(19) United States
(12) Patent Application Publication
(10) Pub. No.: US 2026/0048627 A1
(43) Pub. Date: Feb. 19, 2026

(54) TRAILER THEFT DETERRENT SYSTEM

(71) Applicant: Stevin Lee Jones, Holt, MI (US)

(72) Inventor: Stevin Lee Jones, Holt, MI (US)

(21) Appl. No.: 19/300,786

(22) Filed: Aug. 15, 2025

Related U.S. Application Data
(60) Provisional application No. 63/683,846, filed on Aug. 16, 2024.

(51) Int. Cl. B60D 1/52

(52) U.S. Cl. CPC B60D 1/52

(57) ABSTRACT

A trailer coupler attachment/detachment assembly for quickly and easily removing a trailer coupling from a trailer tongue or a trailer coupling bracket and easily reinstalling the trailer coupling for towing includes first and second coupling pins extending through a first and second sets of aligned fastener holes of the tongue or bracket and the coupler respectively, and first and second retaining pins for securing the coupling pins in the aligned sets of fastener holes.

### CROSS-REFERENCE TO RELATED APPLICATIONS

This application claims priority to U.S. Provisional Application No. 63/683,846, filed Aug. 16, 2024, which is incorporated herein by reference in its entirety.

### FIELD OF THE INVENTION

This disclosure relates to devices and methods for deterring trailer theft, and more particularly to methods and systems using a trailer coupler attachment/detachment assembly that can deny a potential thief access to the trailer coupler.

### BACKGROUND OF THE DISCLOSURE

Trailer theft is a common problem because trailers are viewed by criminals as potentially high value targets that are relatively easy to steal. In many cases, a thief need only back up their vehicle to the trailer, hitch-up, and drive away with the trailer in tow.

Common devices and methods for deterring trailer theft include hitch locks that fit onto or around the hitch coupler to prevent insertion of a trailer hitch ball into the hitch coupler ball receiver, coupler latch locks that prevent latching or unlatching of the coupler, wheel locks or bolts, heavy chains and padlock for locking the trailer to a fixed object, and removal of the bolts that secure the trailer coupler to the trailer tongue and relocating of the trailer coupler where it is inaccessible to thieves. Many of these devices can be thwarted by resourceful thieves using bolt cutters or cutting tools. Removal of the coupler has the advantage of not being overcome with bolt cutters or other cutting tools, but suffers from being cumbersome, time consuming, and risking separation and loss of the bolts or nuts from the coupler. Still other known devices and methods involve expensive modifications to the trailer frame that could adversely affect warranties and/or structural integrity.

Problems existing with trailer security systems, where the current deterrent devices exhibit systematic vulnerabilities to readily available cutting tools and other removal devices, there remains a need for a trailer theft deterrent that provides enhanced security through advanced material engineering and innovative locking mechanisms.

### SUMMARY OF THE DISCLOSURE

Disclosed is a trailer coupler attachment/detachment assembly for quickly and easily removing and installing a trailer coupler onto a tongue or coupler bracket of a trailer frame. The assembly includes a first coupler pin having an axial or length direction, the first coupler pin configured to be inserted through a first set of aligned holes in a trailer coupler and trailer tongue or trailer coupler bracket, and a second coupler pin having an axial or length direction, the second coupler pin configured to be inserted through a second set of aligned holes in the trailer coupler and trailer tongue or trailer coupler bracket. Each of the first coupler pin and second coupler pin have a through-bore transverse to the axial direction of the respective coupler pins. The assembly also includes a retainer plate for holding the first and second coupler pins in a spaced parallel relationship, and first and second retaining pins receivable in the respective transverse through-bores of the coupler pins to hold the assembly in place to secure a trailer coupler to a trailer tongue or trailer coupler bracket.

In certain embodiments, the assembly can include a lock configured to lockably engage a first end of the first coupler pin. For example, the first end of the first coupler pin can be provided with a circumferential recess or groove around its perimeter that can be engaged by a ball, pin or spring-loaded plunger of a lock designed to fit into and positively engage the recess.

The claimed trailer coupler attachment/detachment assembly can prevent most trailer thefts by removing the trailer coupler from the trailer tongue or coupler bracket quickly and efficiently to prevent unauthorized towing and theft of the trailer and its contents from its stored location. This assembly can be easily and quickly installed or removed from the trailer along with the trailer coupler. Conventional locking can be removed through various methods when the coupler remains in place. The claimed trailer coupler attachment/detachment assembly solves this problem by providing the owner with an assembly that allows easy removal of the trailer coupler and reinstallation when towing is desired. The assembly can be reinstalled through the trailer tongue or coupler bracket when the coupler is removed to prevent the installation of a different coupler provided by a potential thief.

To install the disclosed assembly on a new or used trailer, the existing coupler bolts, nuts and washers are removed. On a small percentage of trailers that have a coupler welded to the trailer tongue, the welds are cut, and holes are drilled into the trailer tongue for pins to be inserted. Installation of the assembly involves setting the coupler on the trailer tongue or in the adjustable trailer coupler bracket, aligning the coupler holes in the trailer tongue or coupler bracket with holes through the coupler, and inserting the coupler pins through the aligned holes. Installing the retaining pins through the holes of the coupler pins and/or engaging the pin(s) with a lock (e.g., key-operated or combination lock). To remove the trailer coupler when ready to store or park the trailer, the installation order is reversed. When the coupler is removed and placed in a remote owner designated location the trailer is secure from unauthorized towing.

The device may also have one or more or a combination of the following: individual steel washers, corrosion resistant washers, any combination of steel, rubber, composite, wire or other materials used as the retainer plate. Corrosion resistant carbon steel or stainless-steel adjustable retainer plate or corrosion resistant and or steel fixed hole retainer plate, any other retainer plates made of specialty rubber, plastic, composite, wire or any other combination of materials engineered and deemed suitable for use as the retainer plate. Any metal, composite or other suitable material for the retainer (e.g., lynch pins, cotter pins). Grade rated, corrosion resistant carbon steel or stainless-steel machined coupler pins.

The lock can be key-operated, combination, keyed battery operated, remote controlled, or any other type of lock.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The Removable Trailer Coupler Lockset may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

FIG. 1 illustrates a trailer coupler lockset assembly in accordance with this disclosure.

FIG. 2 illustrates the trailer coupler lockset assembly of FIG. 1 installed on a trailer tongue.

FIG. 3 illustrates the trailer coupler lockset assembly of FIG. 1 installed on a trailer coupler bracket.

### DETAILED DESCRIPTION OF ILLUSTRATED EMBODIMENT

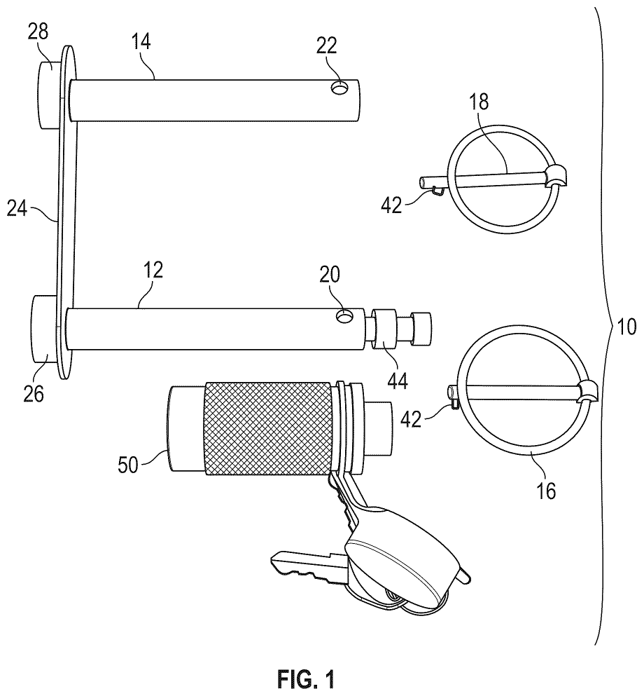

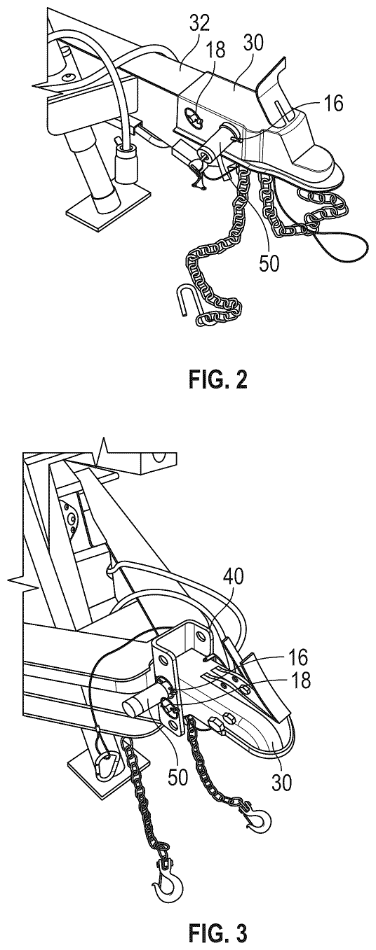

Shown in FIG. 1 is a trailer coupler attachment and detachment assembly 10. The assembly 10 includes a first coupler pin 12. Coupler pin 12 can have a generally cylindrical or rod-like shape to facilitate use as a substitute for the bolts that are typically employed to fasten a trailer coupler to a trailer coupler tongue or a trailer coupler bracket. However, rather than being fixed with threaded nuts, with or without a washer, coupler pin 12 is secured with a retaining pin 16 that is inserted through a bore 20 transverse to the axial or length direction of coupler pin 12. Assembly 10 also includes a second coupler pin 14, generally similar to coupler pin 12 and having a transverse bore 22 for receiving a retaining pin 18. A retainer plate 24 attached to second ends 26, 28 of coupler pins 12, 14, respectively holds pins 12 and 14 in an axially parallel relationship, with the spacing between the axes matching the spacing between pairs of holes in a trailer coupling 30 and trailer tongue 32 (FIG. 2) or between the trailer coupling and a trailer coupling bracket 40 (FIG. 3).

In certain embodiments, coupler pins 20, 22 can be affixed to retainer plate 24 with threaded engagement or welds. This arrangement has the advantage of reducing the risk that parts of the assembly will be separated and lost or misplaced. The arrangement also facilitates quicker installation and removal of the assembly from a trailer.

In certain embodiments, retaining pins 16, 18 can have a detent 42, such as a catch, dog, or spring-operated ball, to help retain pins 16, 18 in bores 20, 22. As another alternative, retaining pins 16, 18 can be cotter pins.

In certain embodiments, the first coupling pin 12 is provided with a surface feature 46 at a first end 44 that is opposite second end 26 to facilitate engagement with a lock 50. The illustrated feature 46 is a circumferential groove or recess around the perimeter of coupler pin 12.

The above description is intended to be illustrative, not restrictive. The scope of the invention should be determined with reference to the appended claims along with the full scope of equivalents. It is anticipated and intended that future developments will occur in the art, and that the disclosed devices, kits and methods will be incorporated into such future embodiments. Thus, the invention is capable of modification and variation and is limited only by the following claims.

1. A trailer coupler attachment/detachment assembly, comprising:
a first coupler pin having an axial direction and configured to be received through first aligned holes in a trailer coupler and trailer tongue or bracket, the first coupler pin having a first end and an opposite second end, and having a first through-bore transverse to the axial direction;
a second coupler pin having an axial direction and configured to be received through second aligned holes in the trailer coupler and trailer tongue or bracket, the second coupler pin having a second through-bore transverse to the axial direction and an opposite second end;
a retainer plate connected to the second end of the first coupler pin and connected to the second end of the second coupler pin to hold the axial direction of the first coupler pin and the axial direction of the second coupler pin in a spaced parallel relationship;
a first retaining pin receivable in the first through-bore for retaining the first coupler pin in the first aligned bolt holes; and
a second retaining pin receivable in the second through-bore for retaining the second coupler pin in the second aligned bolt holes.

2. The trailer coupler attachment/detachment assembly of claim 1, further comprising a lock lockably engageable with a surface feature on the first end of the first coupler pin.

3. The trailer coupler attachment/detachment assembly of claim 1, wherein the first and second coupler pins are threadingly affixed to the retainer plate.

4. The trailer coupler attachment/detachment assembly of claim 1, wherein the first and second coupler pins are welded to the retainer plate.

5. The trailer coupler attachment/detachment assembly of claim 2, wherein the lock is a key-operated lock.

6. The trailer coupler attachment/detachment assembly of claim 2, wherein the lock is a combination lock.

7. The trailer coupler attachment/detachment assembly of claim 1, wherein the first and second retaining pins include a detent.

8. The trailer coupler attachment/detachment assembly of claim 1, wherein the first and second retaining pins are cotter pins.

9. The trailer coupler attachment/detachment assembly of claim 1, wherein the first and second coupler pins and the retainer plate are made of carbon steel or stainless steel.

10. A trailer, comprising:
a trailer frame having a trailer tongue, the trailer tongue having fastener holes;
a trailer coupler having fastener holes aligned with the fastener holes of the trailer tongue;
a first coupler pin extending through a first set of aligned fastener holes;
a second coupler pin extending through a second set of aligned fastener holes;
a first retaining pin receivable in a bore extending transversely through the first coupler pin; and
a second retaining pin receivable in a bore extending transversely through the second coupler pin.

11. The trailer of claim 10, further comprising a lock lockably engageable with the first coupler pin.

12. The trailer of claim 11, wherein the lock is a key-operated lock.

13. The trailer of claim 11, wherein the lock is a combination lock.

14. The trailer of claim 10, wherein the first and second retaining pins include a detent.

15. The trailer of claim 10, wherein the first and second retaining pins are cotter pins.

16. A trailer, comprising:
a trailer frame having a trailer coupler bracket, the trailer coupler bracket having fastener holes;
a trailer coupler having fastener holes aligned with the fastener holes of the trailer coupler bracket;
a first coupler pin extending through a first set of aligned fastener holes;
a second coupler pin extending through a second set of aligned fastener holes;
a first retaining pin receivable in a bore extending transversely through the first coupler pin; and
a second retaining pin receivable in a bore extending transversely through the second coupler pin.

17. The trailer of claim 16, further comprising a lock lockably engageable with the first coupler pin.

18. The trailer of claim 17, wherein the lock is a key-operated lock.

19. The trailer of claim 17, wherein the lock is a combination lock.

20. The trailer of claim 16, wherein the first and second retaining pins include a detent.
